(19) United States
(12) Patent Application Publication
(10) Pub. No.: US 2007/0187567 A1
(43) Pub. Date: Aug. 16, 2007

(54) DISPLAY DEVICE FOR DIECAST MODEL CARS

(76) Inventors: Frank Xsavier Ruane, Moreno Valley, CA (US); Rebecca Mac Ruane, Moreno Valley, CA (US)

Correspondence Address: Michael A. O'Neil;Michael A. O'Neil, P. C., Suite 820, 5949 Sherry Lane, Dallas, TX, 75225, US

(21) Appl. No.: 11/626,947

(22) Filed: Jan. 25, 2007

Related U.S. Application Data
(60) Provisional application No. 60/763,074, filed on Jan. 27, 2006.

(51) Int. Cl. F16M 13/00

(52) U.S. Cl. 248/560

(57) ABSTRACT

A device for vertically displaying diecast model cars including a base and at least one mounting device attached to the base and comprising spring loaded hooks for grippingly engaging the rear wheels of a diecast model car and thereby supporting the diecast model car vertically.

### CROSS-REFERENCE TO RELATED APPLICATION

This application claims priority based on provisional patent application Ser. No. 60/763,074 filed Jan. 27, 2006, the entire content of which is incorporated herein by reference.

### TECHNICAL FIELD

This invention relates generally to display devices and more particularly to devices for displaying diecast model cars vertically.

### BACKGROUND AND SUMMARY OF THE INVENTION

Collecting diecast model cars has become extremely popular, especially due to the increasing popularity of professional stock car racing events such as those sponsored by NASCAR®. Diecast model cars are precision replicas of race cars and other automobiles that are manufactured to scale from metal and/or plastic by means of casting and having as much detail as practical for the given scale.

Diecast model cars are often very expensive; thus, avid collectors desire cases or other devices to display their collections. Existing devices for displaying diecast model cars either individually or collectively are designed to display diecast model cars in the horizontal plane only. Prior to the present invention there has been no device for displaying diecast model cars in the vertical plane. The present invention comprises a display device having a plurality of mounting devices with each mounting device supporting and securing a diecast model car in a vertical orientation.

In accordance with its broader aspects the invention comprises mounting devices that receive the rear wheels of diecast model cars so that the diecast model cars hang from the mounting devices. Each mounting device incorporates at least one spring to add elasticity and thus to make the connection between the mounting device and the diecast models more secure in the event the display device is bumped or otherwise disrupted by a person or an event such as an earthquake. The display device is easily fastened to a wall or other surface in the vertical plane for displaying the diecast model cars supported thereby.

### BRIEF DESCRIPTION OF THE DRAWINGS

A more complete understanding of the present invention may be had by reference to the following Detailed Description when taken in connection with the accompanying Drawings, wherein:

FIG. 1 is a front view of a first embodiment of the present invention;

FIG. 2 is a perspective view of a portion of the embodiment of FIG. 1;

FIG. 3 is an exploded view of the portion of the present invention shown in FIG. 2; and

FIG. 4 is a perspective view of the portion of the present invention shown in FIG. 2 in use.

### DETAILED DESCRIPTION

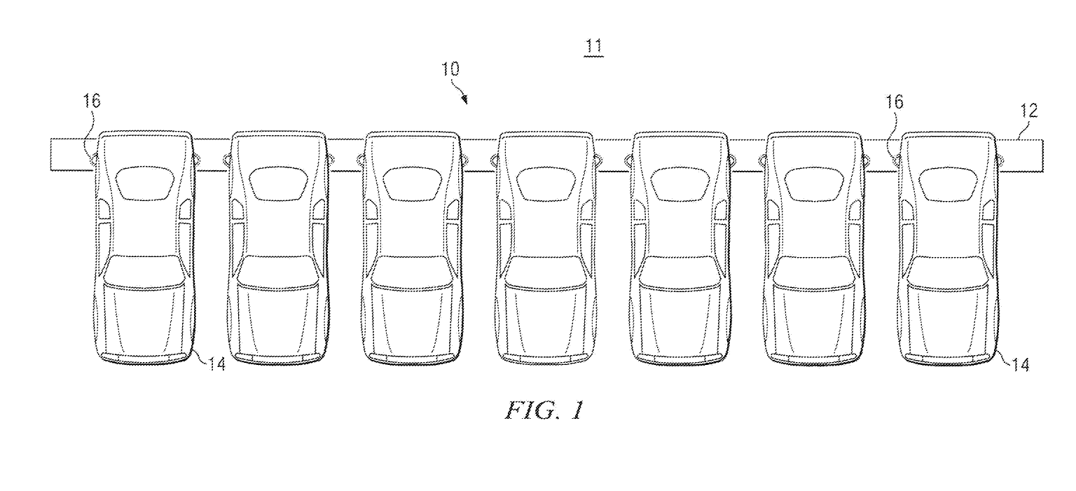

Referring now to the drawings, an in particular to FIG. 1, there is shown a display device 10 comprising the present invention. The display device 10 is shown fastened to a substantially vertical surface 11. The display device 10 includes a base 12 having seven diecast model cars 14 mounted thereon. The diecast model cars 14 are attached to the base 12 by hooks 16 that engage the rear wheels of the cars 14. Although seven diecast model cars 14 are shown supported by the display device 10 it will be understood that the number of cars that may be displayed using the present invention is variable and depends upon the requirements of particular applications of this invention.

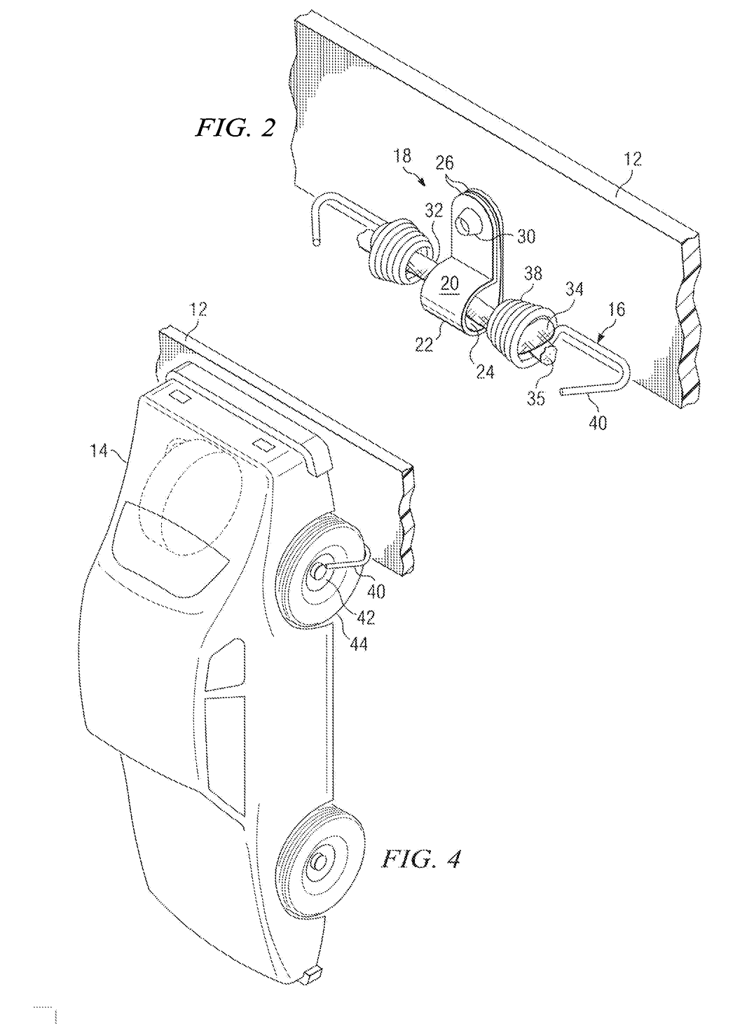

FIG. 2 comprises a perspective view of a portion of the display device 10. In particular there is shown one of the seven mounting devices 18 that are used to attach the diecast model cars 14 to the base 12 of the display device 10.

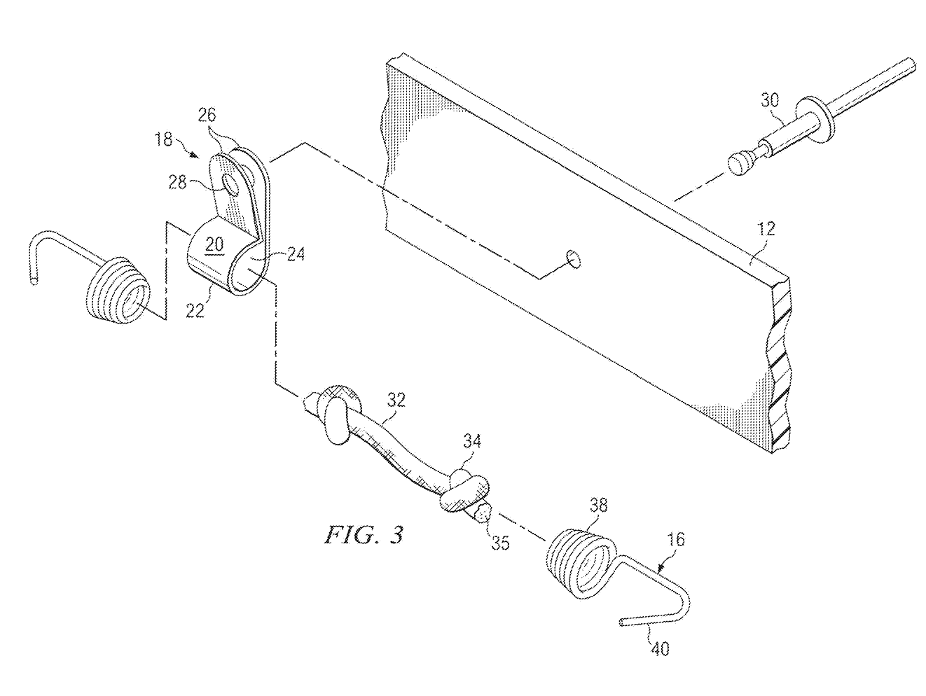

Referring to FIG. 3, the mounting device 18 employs a clamp 20 comprising a circular band 22 that forms a horizontal passageway 24 and two fingers 26 extending outwardly from the circular band 22. The fingers 26 comprise aligned apertures 28 which receive a fastener 30. The fastener 30 compresses the fingers 26 and secures the clamp 20 to the base 12.

An elastic member 32, which may be of the type commonly known as a bungee cord, passes through the passageway 24 and has a knot 34 at each end 35 thereof. A hook 16 is received on each end 35 of the elastic member 32. Each hook 16 comprises a tapered spring 38 at one end that receives the knot 34 at the end 35 of the elastic member 32 and as a curved end 40 that grippingly engages one of the wheels of a diecast model car. In this manner the elastic member 32 and the hooks 16 secure the diecast model car 14 to the base 12 so that the diecast model car 14 is freely support thereon.

FIG. 4 is a perspective view illustrating a diecast model car 14 attached to a portion of the base 12 by the mounting device 18. Specifically the curved end 40 of the hook 16 is received within the recessed inner portion 42 of the rear wheel 44 of the diecast model car 14.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A device for vertically displaying diecast model cars of the type having rear wheels comprising:
a base;
a mounting device;
means for securing the mounting device to the base;
the mounting device comprising means for gripping engagement with the rear wheels of a diecast model car and thereby supporting the diecast model car vertically.

2. A device for vertically displaying diecast model cars of the type having rear wheels comprising:
a base;
a mounting device;
means for securing the mounting device to the base;
the mounting device comprising opposed spring loaded gripping members for grippingly engaging the rear wheels of a diecast model car and thereby supporting the diecast model car vertically.

3. A device for vertically displaying diecast model cars of the type having rear wheels comprising:
a base;
a mounting device;
the mounting device comprising:
an elastic member,
means for securing the elastic member to the base, and
a pair of hooks secured to the elastic member for gripping engagement with the rear wheels of the diecast model car and thereby supporting the diecast model car vertically.
